(19) United States
(12) Patent Application Publication
(10) Pub. No.: US 2006/0075238 A1
(43) Pub. Date: Apr. 6, 2006

(54) Method for processing an analog signal

(75) Inventors: Roland Peter Jan Mathijs Manders, Eindhoven (NL); Gerardus Johannes Maria Vervoort, Eindhoven (NL); Eric Wilhelmus Josephus Moors, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,691

(22) PCT Filed: Nov. 14, 2003
(86) PCT No.: PCT/IB03/05160

§ 371 Date: Jun. 16, 2005

(30) Foreign Application Priority Data
Dec. 17, 2002 (EP) 02080434.0

(51) Int. Cl. H04L 9/00

(52) U.S. Cl. 713/176

(57) ABSTRACT

The present invention relates to a method for processing an analog signal. The method involves hiding a digital watermark signal in the analog signal by combining the watermark signal with the analog signal (103). The watermark signal may be detected and extracted by a device (108) receiving the analog signal. The method includes embedding a key in the watermark signal, such that the key may be extracted and used by an encoding device (108) for encrypting digital content that is based on the analog signal. The invention also relates to an encoding device, which is arranged to perform such encryption.

The present invention relates to a method for processing information corresponding to an analog signal, wherein a watermark signal is hidden in the analog signal in such a way that the watermark signal may be extracted by a device receiving the analog signal.

Such a method is described in U.S. Pat. No. 6,442,285 B2. The watermark may then contain usage control information. If MP3-data is generated from such a signal and the usage control information is transferred to the data, a device receiving such data may check whether the device is authorised to use it or not. If not, the device may refuse to utilise the information, e.g. to play music. The method may thus be used to prevent illicit copying of copyright protected material.

A problem associated with this scheme is that audio/video devices may be produced that do not check the data for usage control information. Such devices may thus use the data regardless of whether they are authorised to do so or not.

It is an object of the invention to wholly or partly obviate this problem. This object is achieved with a method according to the opening paragraph which is characterised by embedding an encryption key in the watermark signal, the encryption key being intended to be identified by an encoding device for using the key to encrypt a digitally coded information sequence corresponding to said analog signal. Thus an encoding device may produce digital data, corresponding to the analog signal, which data may only be used by authorised devices.

In a preferred embodiment, the watermark signal further comprises an instruction about how the encoding device is intended to process the analog signal.

In another preferred embodiment the watermark signal further comprises copyright information.

Preferably, the processing further involves storing data corresponding to the analog signal on a storage medium, or broadcasting a signal corresponding to the analog signal. This allows the protection of copyright interests even when an analog signal is sent in the clear.

According to another aspect, the invention relates to a device for digitally encoding information corresponding to an analog signal. This device is characterised by a watermark detector for detecting a watermark signal, embedded in the analog signal, a key detector for identifying an encryption key in the watermark signal, an encoder for digitally encoding the analog signal and an encrypting unit for encrypting the digitally encoded signal, using the encryption key.

Preferably, the device may further comprise means for retrieving an instruction from the watermark signal about how the analog signal should be processed.

In a preferred embodiment, the device further comprises a decoder for decoding a digital input signal, so that a watermark signal, embedded in an analog signal corresponding to the digital input signal, may be retrieved.

Preferably, the encrypting unit may use a residential key to encrypt encoded analog signals which have no key embedded in a watermark signal or no watermark signal at all.

In a preferred embodiment, the watermark detector, the key detector, the encoder and the encrypting unit are provided on a single integrated circuit. This prevents tampering with the device in order to extract compressed, unencrypted information.

These and other aspects of the invention will be apparent from and elucidated with reference to the embodiments described hereinafter.

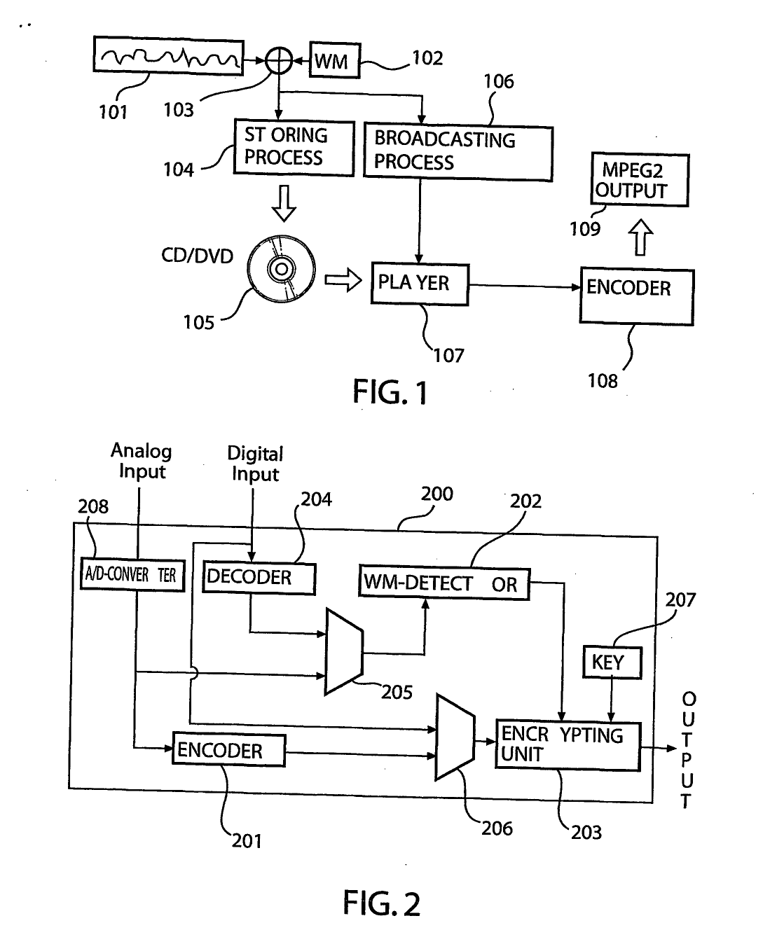

FIG. 1 illustrates a situation where a method and a device according to the invention may be used.

FIG. 2 illustrates an encoding device according to an embodiment of the invention.

FIG. 1 illustrates a situation where a method and a device according to the invention may be used. An analog signal 101, which for instance may be an audio signal or a video signal, is combined with a watermark signal 102 in a combining unit 103. The watermark signal contains data such as copyright information and the like.

Typically, the watermark signal may be a digital signal with a low bit-rate, but any signal that can be subsequently identified and which does not disturb the intended use of the analog signal may be used, i.e. signals that for instance are not audible in an audio signal.

The analog signal may then be processed in any normal way, e.g. it may be converted into a digital format and stored in a storing process 104 on an information medium such as a CD- or a DVD-disk 105, or it may be broadcasted in a broadcasting process 106. In any case, the analog signal is subsequently reproduced in a player 107. The player 107 may be a radio receiver, a CD-player, or the like, that produces an analog output. It may be connected to, or have integrated, an encoder unit 108 that converts the analog output signal from the player 107 into a digital format 109, such as MPEG2 or H264, etc. Information in such formats is highly compressed and may readily be copied and transmitted over computer communication media. Such encoders are available at low cost, but nevertheless produce high quality output. In accordance with the present invention it is suggested to add an encryption key to the watermark signal 102. It is also suggested to modify the encoder unit 108 such that it retrieves the key from the analog signal and encrypts the digital format output 109 utilising the key. In this way illicit copying and spreading of the analog may be obstructed in a more efficient way, since only players with access to the key may reproduce the analog signal.

The digital output from the encoder may preferably be used in a Conditional Access (CA) environment, i.e. a domain where authorised devices, for instance within a home, may exchange information in a secure manner.

Even though a low bitrate digital watermark signal is used, it preferably exceeds 8 bits/s, in order to transmit a sufficiently powerful key within reasonable time. CA environments normally require a 64 bit strong key. If an 8 bit/s watermark signal is used, encryption can thus commence after 8 seconds, which is fast enough for most applications. In any case, the watermark signal is such that it does not disturb the normal use of the analog signal, e.g. the video signal may be viewed in a normal way and the watermark signal is not visible.

The key may preferably be one suitable for use in connection with the standards DES (Data Encryption Standard) or ABS (Advanced Encryption Standard), or a key used in connection with the DVB-standard (Digital Video Broadcasting). However, other encryption schemes are conceivable.

FIG. 2 illustrates an encoding device 200 according to an embodiment of the invention. It comprises an A/D-converter 208 for converting the analog signal to a digital format and an encoder 201 of a conventional type for encoding/compressing the output from the A/D-converter 208. Furthermore, the encoding device comprises a watermark detector 202, for retrieving a watermark, embedded in the analog input. The watermark detector 202 works on the uncompressed, digital version of the analog input and comprises means for identifying an encryption key, hidden in the watermark signal, and feeding this key to an encrypting unit 203. The encrypting unit uses the key to encrypt the encoded output from the encoder 201. This encryption process provides the output from the encoding device 200. Preferably, the encoding device also outputs information needed by authorised devices for decrypting the content, such as the key management structure.

This output may be distributed freely, but only authorised devices, for instance within a CA domain having access to the key, can use it. Moreover, these devices may, when the content has been decrypted, check the analog signal to verify that the correct key was used for encryption, since the watermark key is still present in the analog signal. Since the watermark signal is still present, also further broadcasting of the analog content will be protected in the same way.

The device 200 may also process digital input. Then a decoder 204 is needed to produce an uncompressed digital output that can be used by the watermark detector 202. Multiplexers 205, 206 are used to select whether digital or analog input should be processed.

If no watermark signal is present in the input, or if such a watermark signal lacks encryption key information, the encrypting unit may use a fixed internal key 207.

The watermark detector 202 may furthermore retrieve information from the watermark signal, which information corresponds to instructions on how the encoding device should process the incoming information. For example such instruction can include how the output should be encrypted, that it should not be encrypted or that parts of the output should be encrypted. Other instructions may include whether an included or a residential key should be used, etc.

Preferably, the watermark detector 202, the key detector in the watermark detector, the encoder 201 and the encrypting unit 203 are provided as a single integrated circuit 200. This makes it impossible to tamper with the encoding device in order to extract compressed, unencrypted data.

In summary, the present invention relates to a method for processing an analog signal. The method involves hiding a digital watermark signal in the analog signal by combining the watermark signal with the analog signal. The watermark signal may be detected and extracted by a device receiving the analog signal. The method includes embedding a key in the watermark signal, such that the key may be extracted and used by an encoding device for encrypting digital content that is based on the analog signal. The invention also relates to an encoding device, which is arranged to perform such encryption.

While the invention has been described in connection with a preferred embodiment, it should be understood that the invention should not be construed as being limited to this embodiment. The invention rather includes all variations which could be made thereto by a skilled person and within the scope of the appended claims.

1. Method for processing information corresponding to an analog signal, wherein a digital watermark signal is hidden in the analog signal in such a way that the watermark signal may be extracted by a device receiving the analog signal, characterized by embedding an encryption key in said watermark signal, the encryption key being intended to be identified by an encoding device for using the key to encrypt a digitally coded information sequence corresponding to said analog signal.

2. Method according to claim 1, wherein the watermark signal further comprises instructions on how the encoding device is intended to process the analog signal.

3. Method according to claim 1, wherein the watermark signal further comprises copyright information.

4. Method according to claim 1, wherein said processing further involves storing data corresponding to the analog signal on a storage medium.

5. Method according to claim 1, wherein said processing further involves broadcasting a signal corresponding to the analog signal.

6. Device for digitally encoding information corresponding to an analog signal, characterized by a watermark detector for detecting a watermark signal, hidden in the analog signal, a key detector for identifying an encryption key in the signal and an encrypting unit for encrypting the digitally encoded signal, using the encryption key.

7. Device according to claim 6, further comprising means for retrieving instruction from the watermark signal about how the analog signal should be processed.

8. Device according to claim 6, further comprising a decoder for decoding a digital input signal, such that a watermark signal, embedded in an analog signal corresponding to the digital input signal, may be retrieved.

9. Device according to any of claim 6, wherein the encrypting unit uses a residential key to encrypt encoded analog signals which have no key embedded in a watermark signal.

10. Device according to claim 6, wherein said watermark detector, said key detector, said encoder and said encrypting unit are provided on a single integrated circuit.
